(19) United States
(12) Patent Application Publication
(10) Pub. No.: US 2009/0279986 A1
(43) Pub. Date: Nov. 12, 2009

(54) BINDING TAPE AND A MECHANISM FOR DISPENSING THE SAME

(75) Inventors: Eugene A. Rogalski, JR., Penfield, NY (US); Timothy Kelley, Fairport, NY (US)

Correspondence Address: Hoffmann & Baron, LLP, 6900 Jericho Turnpike, Syosset, NY, 11791, US

(73) Assignee: Xerox Corporation, Norwalk, CT (US)

(21) Appl. No.: 12/117,426

(22) Filed: May 8, 2008

(51) Int. Cl. B42B 9/00

(52) U.S. Cl. 412/16; 222/156; 156/502

(57) ABSTRACT

Embodiments described herein include a binding tape, binding tape dispenser, and a binding system. The binding tape is continuously formed with a flexible substrate and an adhesive disposed on a surface of the substrate. The binding tape dispenser can hold the binding tape and can be used by the binding system to bind objects using the binding tape held by the binding tape dispenser. The binding system pulls the binding tape from the binding tape dispenser and cuts the binding tape to size based on the size of the objects to be bound.

### BACKGROUND

1. Technical Field

The presently disclosed embodiments are directed to binding tapes, binding tape dispensers, and binding systems that use the binding tapes to bind objects.

2. Brief Discussion of Related Art

In recent years, desktop bookbinding machines have provided a low cost alternative to commercial bookbinding. Some bookbinding machines require manual feeding of adhesive strips, while other binding machines have been configured for an automatic feed of adhesive strips.

These conventional adhesive strips are typically discrete pieces that have a predefined length, which corresponds to a size of paper to be bound. In some conventional approaches, these discrete adhesive strips are attached to a carrier material so that the strips can be handled as a unit. When an adhesive strip is fed into the bookbinding machine, the carrier material is removed and the adhesive strip is used to bind sheets of paper.

### SUMMARY

According to aspects illustrated herein, there is provided a binding tape dispenser that includes a binding tape and a dispensing mechanism. The binding tape is continuously formed having a flexible substrate with a thermally activated adhesive disposed thereon. The dispensing mechanism holds the binding tape and is rotatable. The binding tape is unwound and dispensed intact, without any delamination thereof, from the binding tape dispenser when the binding tape is pulled from the binding tape dispenser.

According to other aspects illustrated herein, there is provided a bookbinding device that includes an extracting mechanism and a cutting mechanism. The extracting mechanism pulls binding tape from a binding tape dispenser. The binding tape has a substrate on which a thermally activated adhesive is disposed. The cutting mechanism cuts the binding tape to a desired length based on objects to be bound.

According to yet other aspects illustrated herein, there is provided a binding tape having a continuously formed flexible substrate, a thermally activated adhesive disposed on a surface of the substrate, and at least one demarcation disposed on the binding tape. The demarcation identifies a location at which the binding tape is to be cut.

### BRIEF DESCRIPTION OF THE DRAWINGS

FIG. 1 illustrates an exemplary embodiment of binding tape that can be used to bind objects.

FIG. 2 depicts a surface of binding tape to illustrate exemplary demarcations and indicia that can be disposed thereon.

FIG. 3 depicts an exemplary binding tape dispenser for holding binding tape.

FIGS. 4-6 depict an exemplary bookbinding system with a severing mechanism for severing binding tape that is dispensed from a binding tape dispenser.

FIG. 7 depicts another exemplary embodiment of a severing mechanism for severing binding tape that is dispensed from a binding tape dispenser.

### DETAILED DESCRIPTION

Exemplary embodiments include a binding tape that can be used to bind objects, such as sheets of paper, parchment, and the like. The binding tape can have continuously formed substrate with a heat activated adhesive for binding objects disposed thereon, such as sheets or paper, parchment, or the like. The binding tape can be held in a binding tape dispenser, which allows the binding tape to be dispensed, manually or automatically, using a binding system. The binding system can cut the binding tape to a desired length based on the length of the objects to be bound, which may be indicated by demarcations disposed on the binding tape.

As used herein, “binding” refers to a process of joining, fastening, securing, attaching, and the like, objects, such as sheets of paper, parchment, or other materials, together to form a unit that is composed of the objects.

As used herein, “binding tape” refers to a substrate that has an adhesive disposed thereon, which is used to bind objects. The substrate can be a flexible material sufficient for receiving an adhesive, such as plastic, paper, and the like and the adhesive can be a thermally activated adhesive, which refers to a material that becomes tacky or sticky when it is exposed to a sufficient amount of heat.

As used herein, a “binding tape dispenser” refers to a receptacle that holds binding tape and from which the binding tape is dispensed.

As used herein, a “demarcation” refers to a marker or indication as to the location at which the binding tape should be cut. In some embodiments, the demarcations can be perforations, which refer to openings formed in the binding tape, such as holes, slits, slots, and the like. The perforations do not sever the binding tape into sections, but provide a weakened location that promotes severing.

The terms “sever” and “cut” are used interchangeably herein and refer to separating, dividing, or tearing a section of binding tape from the main portion of the binding tape.

A “binding system” refers to a device that receives the binding tape, sufficiently heats the binding tape so that the thermally activated adhesive becomes sticky or tacky, and binds objects, such as sheets of paper, using the binding tape.

A used herein, “delamination” refers to splitting or separating layers. The layers need not be adhesively joined.

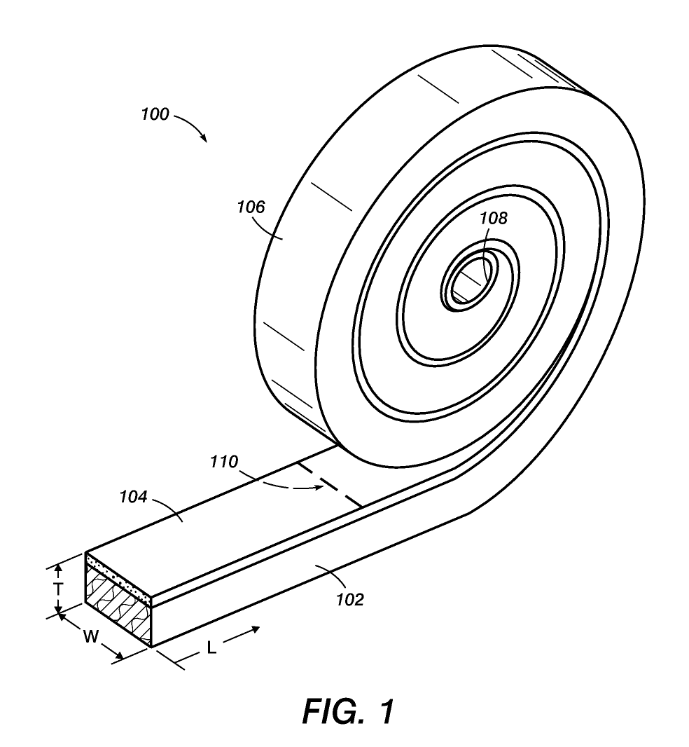

FIG. 1 depicts an exemplary embodiment of a binding tape 100 that can be formed as a substantially continuous flexible ribbon or band having a substrate 102 with a thermally activated adhesive 104 (hereinafter “adhesive 104”) disposed thereon. The binding tape 100 can be wound into a roll 106 or other configurations that enable the binding tape to be dispensed. The roll 106 can be wound around a reel 108, which can be formed from a material of sufficient strength to hold the roll 106 of binding tape 100. For example, the reel 108 can be formed from a metal, plastic, cardboard, and the like. The binding tape 100 is generally longer than the objects to be bound and the binding tape 100 is generally cut to size by the binding system as described below.

The substrate 102 can be implemented as a flexible material, such as a polymer, paper, cotton-based material, polyester, nylon, and/or other materials that are flexible and that can withstand the heat necessary to activate the adhesive 104. The substrate 102 can be a single ribbon or band and can have various widths W, lengths L, and thicknesses T.

The adhesive 104 is disposed on one more surfaces of the substrate, such as a front and/or back surface, and can include a low viscosity, low tack adhesive and/or a high viscosity, high tack adhesive. The high tack, high viscosity adhesive can function to secure the binding tape 100 with one surface exposed such as where the binding tape 100 is secured to the front and/or back of outer objects, such as front and back covers of a book to be bound. The low tack, low viscosity adhesive can function to secure the binding tape 100 between objects, such as between the front and back covers. Here, the low viscosity adhesive may be allowed to flow slightly between the objects during the binding process. The adhesive 104 can be, for example, an ethylene vinyl acetate based adhesive, amorphous polyalphaolefin (APAO) based adhesive, block copolymer adhesive, and/or other suitable adhesive for binding objects.

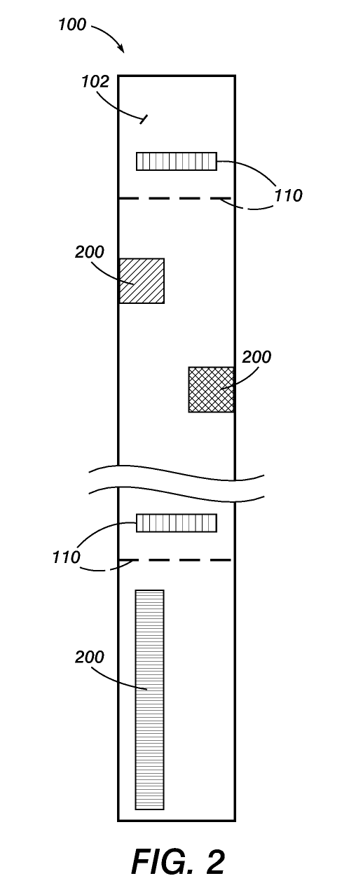

As showing in FIGS. 1 and 2, one or more demarcations 110 are spaced along the binding tape 100. The demarcations 110 can be, for example, perforations, ink marks, magnetic materials, or other marking that can be detected by a binding system to identify a location at which the binding tape 100 is to be severed. A binding system can sever the binding tape 100 at or near the demarcation 110 to create a severed section of binding tape 100 that can be used by the binding system to bind objects.

The demarcations 110 can be spaced to correspond to a particular object size, such as a paper size, for example, letter (8½ inches by 11 inches), A4 (8 inches by 14 inches), or the like. In some embodiments, the binding tape 100 can have demarcations 110 that correspond to different object sizes so that the binding tape 100 can be used for multiple object sizes, such as both letter and A4 paper. Different demarcations 110 may be utilized to designate different object sizes. Such embodiments can allow a user to bind different sized objects without requiring the user to change the binding tape 100 being used.

The binding tape 100 can include indicia 200 (FIG. 2) that can be disposed on the binding tape 100 and/or a binding tape dispenser, which is discussed in more detail below. For example, the indicia 200 can be printed on the surface of the substrate 102 that does not have adhesive 104 disposed thereon or can be disposed on a surface of the binding tape dispenser. The indicia 200 can be, for example, one or more glyphs, bar codes, colors, shapes, magnetic materials, and the like, and can be used by a binding system during the binding process to control various aspects of the binding system, such as when to start and/or stop the binding process or when to indicate a status of the binding tape, such as, for example, that the binding tape 100 is almost finished (e.g., when a roll of the binding tape 100 is almost depleted). The indicia 200 can also be used for determining operating statistics such as the rate at which the binding tape 100 is being used.

Multiple distinct indicia 200 may be disposed on the binding tape 100, which can correspond to different functions to be implemented by a binding system or there can be identical indicia 200, which correspond to different functions to be implemented by the binding system based on the location of the indicia 200 on the binding tape 100. In one embodiment, the indicia 200 can be used to count how many objects of a particular size (e.g., letter size paper or A4 size paper) have been bound or how many more objects of a particular size can be bound before the binding tape 100 in the dispenser is depleted. In other embodiments, the indicia 200 can indicate the width, color, type, or other characteristics of the binder tape 100.

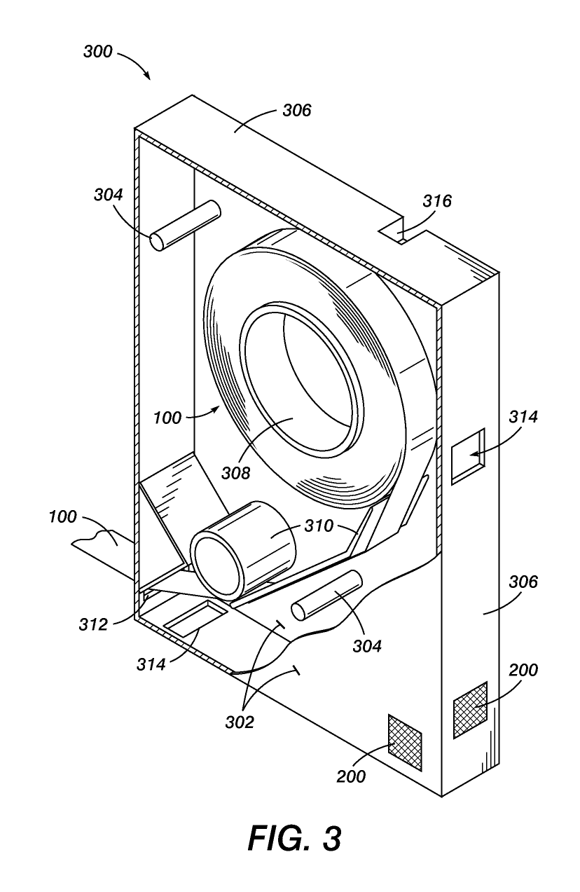

Referring to FIG. 3, the binding tape 100 can be held in a binding tape dispenser 300 (hereinafter “dispenser 300”) that can be operatively coupled to a binding system so that the binding system can pull the binding tape 100 from the dispenser 300 during the binding process. The dispenser 300 can be formed from metal, paper, cardboard, plastic, or the like, and in some embodiments can be reusable such that when the dispenser 300 is empty (i.e. does not have binding tape 100 held therein), more binding tape 100 can be loaded into the dispenser 300 for subsequent use.

The dispenser 300 can include opposing walls 302, reinforcing structures 304, side walls 306, a dispensing mechanism 308, and guides 310. The opposing walls 302 can be spaced apart so that the binding tape 100 can fit between the opposing walls 302. The reinforcing structures 304 can be operatively coupled to the opposing walls 302 to provide support and rigidity to the dispenser 300. The reinforcing structures 304 can be formed from metal, paper, cardboard, plastic, and the like, to strengthen the dispenser 300 and to prevent the opposing walls 302 from collapsing. The side walls 306 can operatively couple the perimeters of the opposing walls 302 for additional support and can be formed of the same material from which the opposing walls 302 are formed or can be formed of a different material. An outlet port 312 can be formed in at least one of the side walls 306 to provide an opening through which the binding tape 100 can be dispensed. In some embodiments, the dispenser 300 can include one or more openings 314, which can be formed to expose the binding tape within the dispenser 300. The openings 314 can be configured to align with one or more sensors associated with the binding system when the dispenser 300 is operatively coupled to the binding system.

The dispensing mechanism 308 can be configured between the opposing walls 302 and can be operatively and rotatably coupled thereto. The dispensing mechanism 308 can be formed from metal, plastic, paper, or cardboard, or other materials that can support the binding tape 100. In some embodiments, the dispensing mechanism 308 can be integrated into the reel 108 (FIG. 1) of the binding tape 100 such that the reel 108 is operatively and rotatably mounted in the dispenser 300. The binding tape 100 can be centrally located within the dispenser 300 so that the capacity of the dispenser 300 to hold the binding tape 100 is maximized. Additionally, because the binding tape 100 is continuously formed, the absence of a carrier allows more binding tape to be held in the dispenser 300.

The guides 310 can be used to guide the binding tape 100 within the dispenser 300 from the reel 108 to the outlet port 312 when the binding tape 100 is being dispensed. In some embodiments, the guides 310 can be used to maintain tension on the binding tape 100 when the binding tape 100 is being dispensed. The guides 310 can be fixedly, rotatably, pivotably, or flexibly positioned.

The binding tape 100 is dispensed from the dispenser 300 intact in the same form as the binding tape 100 has on the reel 108. No portion of the binding tape 100 is delaminated or otherwise altered. For example, no backing or carrier layer is delaminated or separated from the binding tape 100 in the dispenser 300 prior to dispensing.

As discussed above, the dispenser 300 can also include indicia 200. The indicia 200 can be disposed on one or more of the opposing walls 302 and/or side walls 306. In some embodiments, the dispenser 300 can include notches or cutouts 316 that can be used by the binding system in a similar manner to the indicia 200. The indicia 200 disposed on the dispenser 300 and/or the notches or cutouts 316 can be used by a binding system to determine one or more characteristics of the binding tape 100 held by the dispenser 300, such as a length of the roll of binding tape 100, a width of the binding tape 100, a type of adhesive 104, a length of object to be bound with the binding tape 100, and the like.

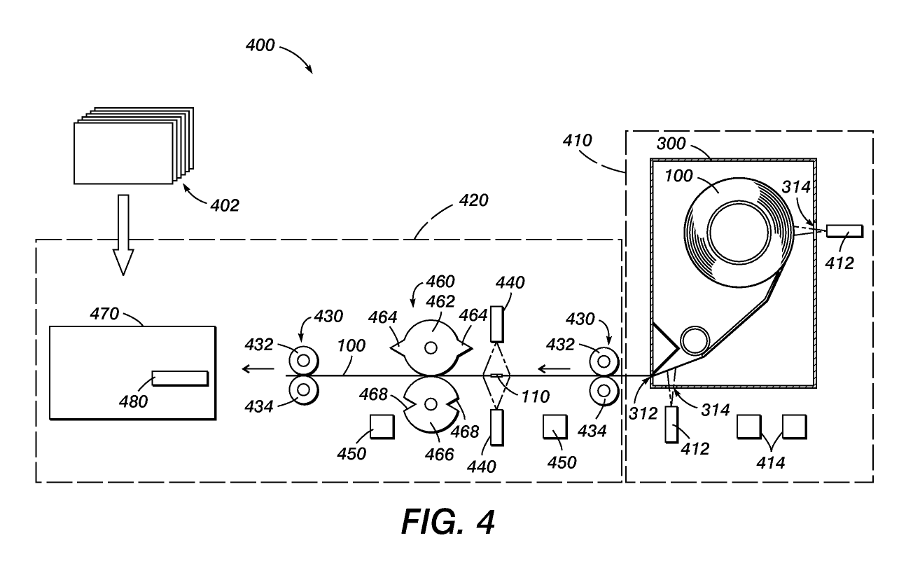

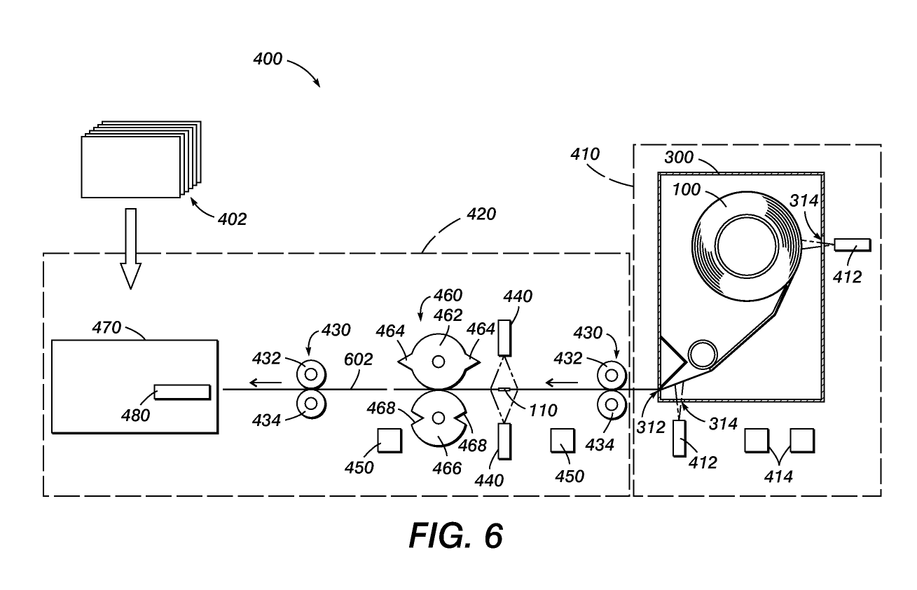

FIGS. 4-7 illustrate an exemplary bookbinding system 400 (hereinafter “system 400”) that can be implemented to bind objects 402, such as sheets of paper or other materials. The system 400 includes a dispenser holder 410 (hereinafter “holder 410”) and a binding device 420. The dispenser 300, with the binding tape 100 contained therein, can be placed in the holder 410 and the binding device 420 can pull the binding tape 100 from the dispenser 300 so that the binding tape 100 can be used to bind objects 402.

The holder 410 can include one or more sensors 412 and controllers 414 and can be configured to receive the dispenser 300 so that at least one of the openings 314 in the dispenser 300 align with at least one of the sensors 412 when the dispenser 300 is placed in the holder 410. The one or more sensors 412 can be used to sense the indicia 200 disposed on the binding tape 100 and/or the dispenser 300. The one or more sensors 412 can be an optical sensor, proximity sensor, or other type of sensor that is suitable for detecting the demarcations and indicia of the binding tape 100.

The one or more controllers 414 can control the operation of the one or more sensors 412 as well as other functions performed by the binding system 400, such as indicating that the binding tape 100 is near depletion. In some embodiments, the sensors 412 can sense the indicia 200 disposed on the binding tape 100 and the controllers 414 can perform a function in response to the sensed indicia. In some embodiments, the holder 410 may not include controllers 414. In such embodiments, the sensors 412 can be controlled by controllers associated with the binding device 420.

The binding device 420 can include extracting mechanism 430, sensors 440, controllers 450, and a severing mechanism 460, as well as other components, such as a clamping unit 470 and a heating unit 480. The extracting mechanism 430 pulls the binding tape 100 from the dispenser 300. In one embodiment, the extracting mechanism 430 can include one or more pairs of opposing rollers that rotate in opposite directions arranged to define a nip therebetween for receiving the binding tape 100. For example, a top roller 432 can rotate in a clockwise direction and a bottom roller 434 can rotate in a counter clockwise direction. The rollers 432 and 434 can pull the binding tape 100 from the dispenser 300 using, for example, a frictional force between the rollers 432 and 434 and the binding tape 100.

The sensors 440 can be positioned above and/or below the binding tape 100 to detect the demarcations 110 and/or indicia 200 disposed in the binding tape 100. The sensors 440 can be optical sensors, proximity sensors, or other types of sensors that are suitable for detecting the demarcations 110 and indicia 200 associated with the binding tape 100. The sensors 440 can be placed in close proximity to the severing mechanism 460 so that when the sensor 440 senses a demarcation 110 the severing mechanism 460 can be controlled to sever the binding tape 100.

The controllers 450 in the binding device 420 can be used to control the operation of the binding device 420. For example, the controllers 420 can control the sensors 440 and sensor 412 and use information sensed by the sensors 440 and 412 to perform various operations, such as severing of the binding tape 100 or indicating that the dispenser 300 is almost out of binding tape 100. The controllers 450 can also control the rate at which the extracting mechanism 430 operates to pull the binding tape 100 from the dispenser 300 and can control the clamping and heating units 470 and 480, respectively.

The severing mechanism 460 can be formed by a pair of opposing rollers, arranged to define a nip therebetween formed to receive the binding tape 100, that can have a generally elliptical configurations. One of the rollers can be a cutting roller 462 with, for example, one or more cogs 464 extending therefrom, that are capable of severing the binding tape 100. Another one of the rollers can be a receiver roller 466 that has one or more recessed portions 468, configured to receive the cog 464 of the cutting roller 462. The severing mechanism 460 can sever the binding tape 100 in response to the sensor 440 sensing a demarcation 110 so that the binding tape 100 is cut to a desired length, which can correspond to the size of the objects, such as letter or A4 sized sheets of paper, to be bound.

In some embodiments, the cutting roller 462 and receiver roller 466 can each have a circumference that is substantial equal to a desired length of binding tape 100 to be used to bind objects 402. For example, the objects 402 to be bound can be sheets of letter sized paper such that the desired length of the binding tape 100 for binding the sheets is 11 inches, which corresponds to the length of letter sized paper. In this example, the cutting and receiving rollers 462 and 466, respectively, can have circumferences that are substantially equal to 11 inches. In these embodiments, the binding system 400 may not use the sensors 440 for detecting the demarcations 110 since the binding device 420 severs the binding tape 100 according to the circumference of the rollers 462 and 466. Likewise, in these embodiments, the binding tape 100 may not include the demarcations 110 since the binding device 420 may not use the demarcations 110 to determine when to sever the binding tape 100.

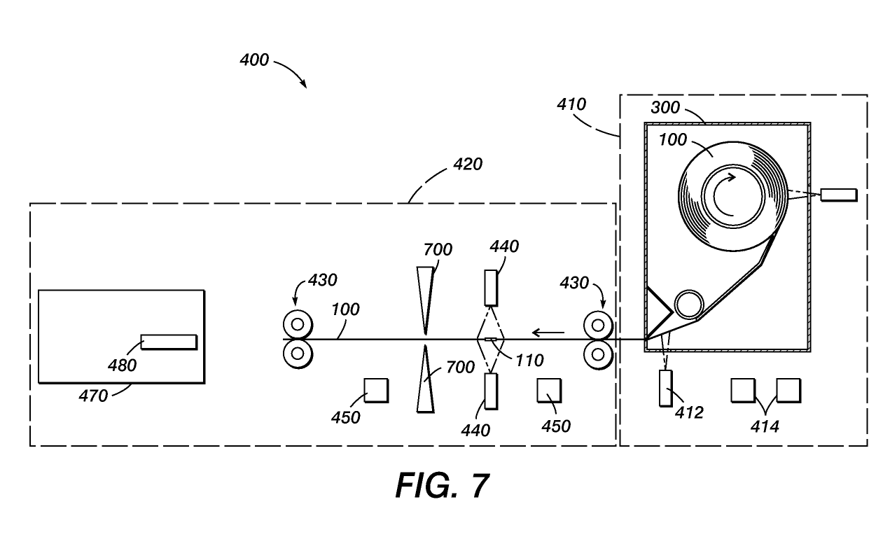

In other embodiments, the severing mechanism 460 can include one or more blades 700 (FIG. 7) or other structures that are suitable for severing the binding tape 100. To cut the binding tape 100, one or more of the blades 700 can be adjusted to contact the binding tape 100 with sufficient pressure to sever the binding tape 100.

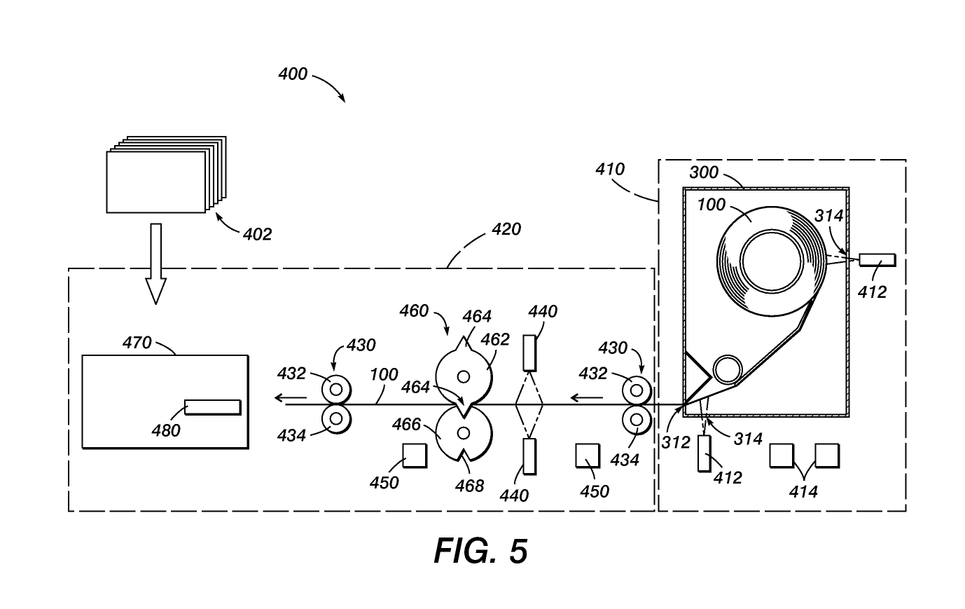

Still referring to FIGS. 4-7, in operation, the dispenser 300 that holds the binding tape 100 can be placed in the holder 410. To initialize the binding process, the binding tape 100 can be positioned so that the extracting mechanism 430 can begin pulling the binding tape 100 from the dispenser 300. As the binding tape 100 is being dispensed, the sensors 412 and 440 can be operative to sense the demarcations 110 and indicia 200 that are disposed on the binding tape 100. For example, one of the sensors 440 can detect a demarcation 110 (FIG. 4). Once the sensor 440 has detected a demarcation 110, the sensor 440 can send a signal to one or more of the controllers 450, which in response can operate the severing mechanism 460 to sever the binding tape 100 at or near the demarcation 110 (FIG. 5).

The binding tape 100 can be dispensed from the dispenser 300 at a rate which can be controlled by the extracting mechanism 430. The severed section of binding tape 602 is passed to the clamping unit 470 using any technique.

The severed section of binding tape 602 is placed in contact with the objects 402 and clamped in place by the clamping unit 470. For example, the clamping unit 470 can clamp the severed section of binding tape 602 around the spine of pages to be bound as a book and the heating unit 480 can apply heat to activate the adhesive to secure the pages to the severed section of binding tape 602. Heat is applied to the severed section of binding tape 602 and objects 402 to activate the adhesive and secure objects 402 to the severed section of binding tape 602. The objects 402 can be pushed against the severed section of binding tape 602 with pressure to ensure that the objects are bound sufficiently. Subsequently, the severed section of binding tape 602 is cooled or allowed to cool, to harden or cure the adhesive, thereby binding objects.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A binding tape dispenser comprising:
a continuously formed binding tape having a flexible substrate with a thermally activated adhesive disposed thereon; and
a dispensing mechanism on which the binding tape is held, the dispensing mechanism being rotatable, the binding tape being unwound and dispensed intact, without any delamination thereof, from the binding tape dispenser when the binding tape is pulled from the binding tape dispenser.

2. The binding tape dispenser of claim 1, wherein the binding tape comprises a plurality of demarcations indicating at least one location at which the binding tape is to be cut, the demarcations being spaced along the binding tape.

3. The binding tape of claim 2, wherein the plurality of demarcations comprise perforations.

4. The binding tape of claim 2, wherein the plurality of demarcations are spaced based on a size of the object to be bound.

5. The binding tape dispenser of claim 1, wherein the binding tape comprises indicia for identifying at least one of a characteristic of the binding tape and a status of the binding tape.

6. The binding tape dispenser of claim 1, wherein the binding tape dispenser is reusable.

7. The binding tape dispenser of claim 1, wherein the binding tape dispenser further comprises walls within which the binding tape is held, at least one of the walls configured with an opening that exposes the binding tape.

8. A bookbinding system comprising:
an extracting mechanism for pulling a binding tape from a binding tape dispenser, the binding tape having a substrate on which a thermally activated adhesive is disposed; and
a severing mechanism for severing the binding tape at a desired length based on objects to be bound.

9. The bookbinding device of claim 8, wherein the severing mechanism comprises:
a cutting roller having a cog extending therefrom, the cog being configured to cut the binding tape; and
a receiver roller having a recess for receiving the cog of the cutting roller.

10. The bookbinding device of claim 9, wherein the cutting roller comprises a circumference that is substantially equal to the desired length.

11. The bookbinding device of claim 8, further comprising a sensor for detecting a demarcation on the binding tape, the severing mechanism cutting the binding tape in response to the detection of the demarcation by the sensor.

12. The bookbinding device of claim 8, further comprising a sensor for detecting indicia on the binding tape, the indicia indicating at least one of a characteristic of the binding tape and a status of the binding tape.

13. A binding tape comprising:
a continuously formed flexible substrate;
a thermally activated adhesive disposed on a surface of the substrate; and
at least one demarcation disposed on the binding tape, the at least one demarcation identifying a location at which the binding tape is to be cut.

14. The binding tape of claim 13, wherein the demarcation comprises perforations.

15. The binding tape of claim 13, wherein the demarcation comprises an ink mark.

16. The binding tape of claim 13, wherein a plurality of demarcations are spaced along the binding tape according to the length of objects to be bound.

17. The binding tape of claim 13, further comprising indicia disposed thereon that identifies a characteristic of the binding tape.
